(19) United States
(12) Patent Application Publication
(10) Pub. No.: US 2015/0014171 A1
(43) Pub. Date: Jan. 15, 2015

(54) MICROFLUIDIC PARTICLE SEPARATION DEVICE

(71) Applicant: National Taiwan University, Taipei City (TW)

(72) Inventors: Shiang-Chi LIN, Taipei City (TW); Chih-Ting LIN, Taipei City (TW); Yi-Chung TUNG, Taipei City (TW); Yu-Lung SUNG, Taipei City (TW)

(73) Assignee: National Taiwan University, Taipei City (TW)

(21) Appl. No.: 14/264,141

(22) Filed: Apr. 29, 2014

(30) Foreign Application Priority Data
Jul. 11, 2013 (TW) 102124900

(51) Int. Cl. B03C 5/00; B03C 5/02

(52) U.S. Cl. CPC B03C 5/005; B03C 5/028
USPC 204/643

(57) ABSTRACT

A microfluidic particle separation device includes a substrate and a plurality of electrode bars formed on the substrate, disposed around as array center, angularly spaced apart from one another, and extending radially with respect to the array center so as to form a radially-extending electrode array that is capable of inducing circular or elliptical shear flow of the liquid through travelling-wave electroosmosis when being applied with a travelling-wave electric potential.

### CROSS-REFERENCE TO RELATED APPLICATION

This application claims priority of Taiwanese Patent Application No. 102124900, filed on Jul. 11, 2013.

### BACKGROUND OF THE INVENTION

1. Field of the Invention

This invention relates to a microfluidic particle separation device, more particularly to a microfluidic particle separation device including a plurality of electrode bars arranged in a radially-extending electrode array.

2. Description of the Related Art

Lab on chip technology involves miniaturization and integration of a plurality of devices with different functions on a chip. In particular, lab on chip is important in small-volume sample preparation and/or medical sample testing.

A microfluidic device is a typical example of an application of the lab on chip technology for small-volume sample preparation and sample testing. However, most conventional microfluidic devices require an additional fluid pumping device for driving movement of the liquid sample, which is a hindrance when integrating with other emerging on-chip devices. In addition, interconnections between the fluid pumping device and the microfluidic device may cause damage to biological samples, and ensuring reliable interconnections is tedious and requires expertise.

### SUMMARY OF THE INVENTION

An object of the present invention is to provide a microfluidic particle separation device for separating particles of different sizes in a liquid.

According to this invention, there is provided a microfluidic particle separation device that comprises: a substrate; and a plurality of electrode bars formed on the substrate. disposed around an array center, angularly spaced apart from one another, and extending radially with respect to the array center so as to form a radially-extending electrode array that Is capable of inducing circular or elliptical shear flow of the liquid through travelling-wave electroosmosis when being applied with a travelling-wave electric potential.

Every two adjacent electrode bars cooperatively define therebetween, a gap that has a width which varies with the radius of the radially-extending electrode array so as to induce a radial dielectrophoretic force acting on the particles through radial dielectrophoresis.

### BRIEF DESCRIPTION OF THE DRAWINGS

In drawings which illustrate embodiments of the invention,

FIG. 1 is a perspective view of the preferred embodiment of a microfluidic particle separation device according to the present invention;

FIG. 2 is a perspective view illustrating forces on a particle in the microfluidic particle separation device of the present invention;

FIG. 3 and FIG. 4 are top views illustrating different configurations of electrode bars of the microfluidic particle separation device of the present invention;

FIG. 5 is a schematic diagram illustrating a simulation model of the microfluidic particle separation device of the present invention, in which a set of four electrode bars are applied with an alternating current signal;

FIG. 6 is a diagram showing a pumping velocity versus the radius of an electrode array of the microfluidic particle separation device of the present invention;

FIG. 7 is a schematic diagram illustrating another simulation model of the microfluidic particle separation device of the present invention, in which a set of two electrode bars are applied with an alternating current signal;

FIG. 8 is a diagram illustrating an electric field distribution in an angular direction (E_{A}) and a radial direction (E_{R});

FIG. 9 is a diagram illustrating gradients of angular electric field strength as a function of radius at different levitation heights from a surface of the electrode bars;

FIG. 10 is a diagram illustrating time-sequence behavior of particles having a diameter of 15 μm; and

FIG. 11 is a diagram illustrating time-sequence behavior of particles having a diameter of 1 μm.

### DETAILED DESCRIPTION OF THE PREFERRED EMBODIMENTS

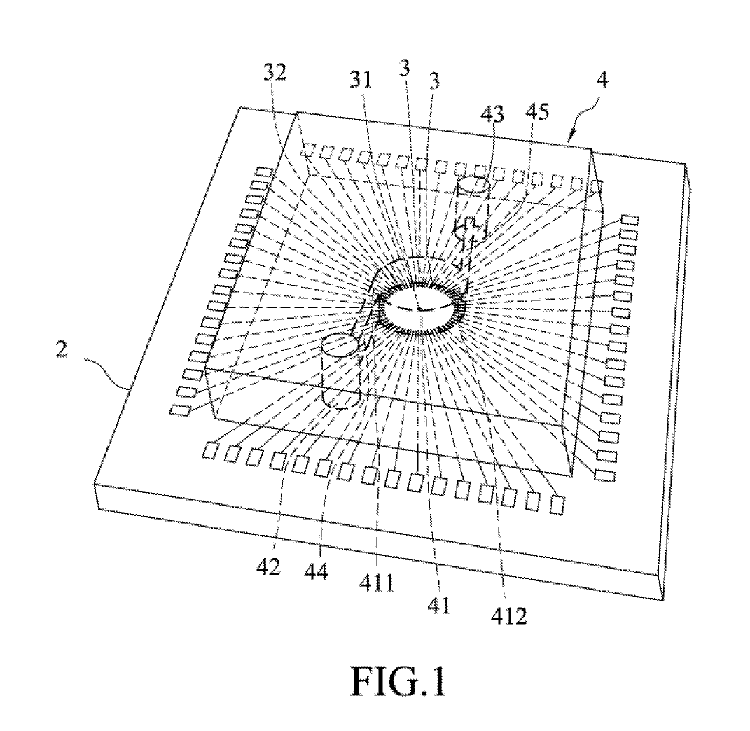

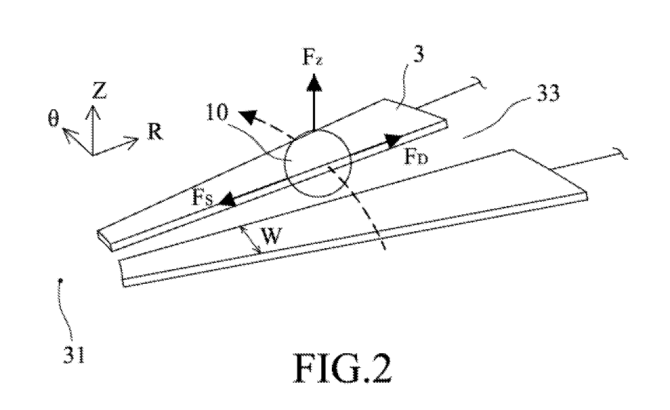

FIG. 1 illustrates the first preferred embodiment of a microfluidic particle separation device according to the present invention. FIG. 2 illustrates different forces on a particle 10 in the microfluidic particle separation device according to present invention. The microfluidic particle separation device is used to separate the particles 10 of different sizes in a liquid (not shown).

The microfluidic particle separation device comprises a substrate 2 and a plurality of electrode bars 3 which are formed on the substrate 2, which are disposed around an array center 31, which are angularly spaced apart from one another, and which extend radially with respect to the array center 31 so as to form a radially-extending electrode array 32 that is capable of inducing circular or elliptical shear flow of the liquid through travelling-wave electroosmosis when being applied with a travelling-wave electric potential.

Every two adjacent electrode bars 3 cooperatively define therebetween a gap 33 that has a width which varies with the radius of the radially-extending electrode array 32 from the array center 31 so as to induce a gradient of an angular electric field which induces a radial dielectrophoretic (DEP) force (F_{D}) acting on the particles 10 through radial dielectrophoresis. In this embodiment, the width of the gap 33 increases with the radius of the radially-extending electrode array 32, so that the radial DEP force (F_{D}) drags the particles 10 in an outward direction away from the array center 31 of the radially-extending electrode array 32.

The microfluidic particle separation device of the first preferred embodiment further comprises a liquid container body 4 which is disposed on the substrate 2 and which is formed with a chamber 41 that is adapted to receive the liquid therein and that has a closed end 411 and an open end 412 opposite to the closed end 411. The open end 412 of the chamber 41 has a periphery that is in contact with the substrate 2, and that surrounds the radially-extending electrode array 32.

In the first preferred embodiment, the chamber 41 of the liquid container body 4 is cylindrical in shape. The liquid container body 4 is further formed with an inlet port 42, an outlet port 43, an inlet channel 44 interconnecting the inlet port 42 and the chamber 41, and an outlet channel 45 interconnecting the outlet port 43 and the chamber 41.

In the first preferred embodiment, there are sixty-four electrode bars 3. Each of the electrode bars 3 has a shape of sector of a torus and has a width W that is equal to that of a gap 33 between two adjacent electrode bars 3 at the same radius of the radially-extending electrode array 32. In the first preferred embodiment, the minimum width W of the electrode bars 3 and the gap 33, which is located at an inner end of the radially-extending electrode array 32, is 5 μm.

When the electrode bars 3 are applied with an alternating current signal with a voltage Vᵢ, which is equal to V₀ cos (ωt+φ₁), where the phase terms φ₁ are 0°, 90°, 180°, and 270° in sequence, travelling wave electric fields on the radially-extending electrode array 32 are induced. The travelling wave electric fields induce a circular shear flow in an angular direction, such that movement of the particles 10 of different sizes in the liquid follows a circular streamline.

It is noted that the flow velocity of the circular shear flow changes with the radius of the radially-extending electrode array 32, which generates a velocity gradient in the radial direction, which, in turn, results in a shear stress-induced force (Fₛ) toward the region with the highest velocity circular flow, i.e., the inner end of the radially-extending electrode array 32. On the other hand, there is an upward dielectrophoresis (DEP) force (F_{z}) along the z-direction acting on the particles 10 of larger size (greater than 1 μm) because of a non-uniform electric field induced above the radially-extending electrode array 32. The upward DEP force F_{z} is opposite to the gravitational force, and causes levitation of the particles 10 of larger size. The radial DEP force (F_{d}) reduces with the levitation height of the particles 10. As such, the different forces acting on the particles 10 through the circular traveling-wave electroosmosis permit separation of the particles 10 of different sizes in the liquid.

Preferably, each of the electrode bars 3 is rectangular in shape. Alternatively, each of the electrode bars 3 has a width which increases with the radius of the radially-extending electrode array 32.

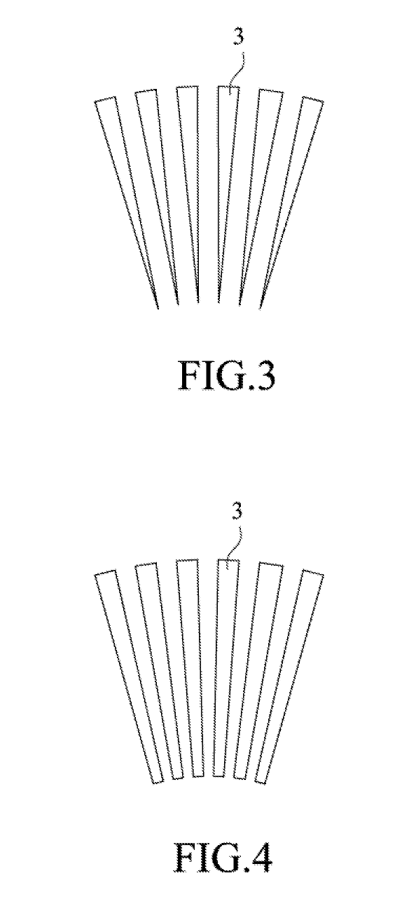

FIGS. 3 and 4 illustrate modified shapes of the electrode bars 3, which are triangular and trapezoidal, respectively.

<Simulation Result>

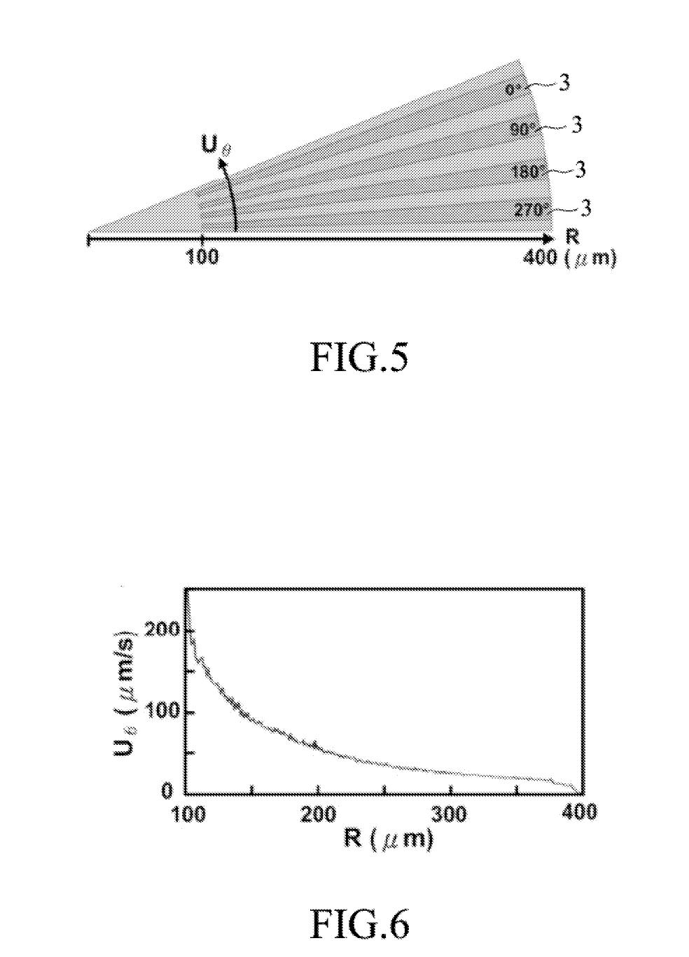

FIG. 5 illustrates a simulation model of a set of four electrode bars 3, which are applied with an alternating current signal with a voltage Vᵢ (Vᵢ=V₀ cos(ωt+φᵢ)), in which the phase terms φᵢ are 0°, 90°, 180°, and 270° sequence. The results of the simulation are shown in FIG. 6, which shows the relation between a pumping velocity of the microfluidic particle separation device versus the radius of the radially-extending electrode array 32. The pumping velocity is defined as an average velocity along the angular direction. The simulation results show that the pumping velocity decreases with the radius of the radially-extending electrode array 32.

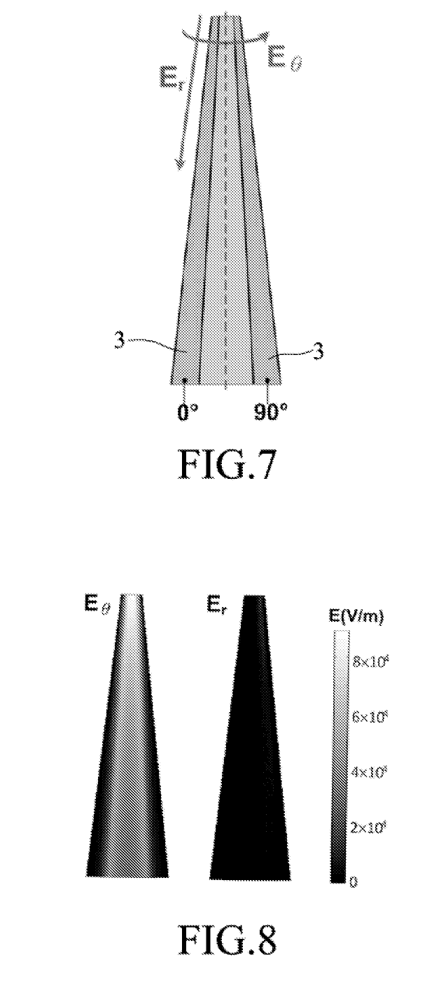

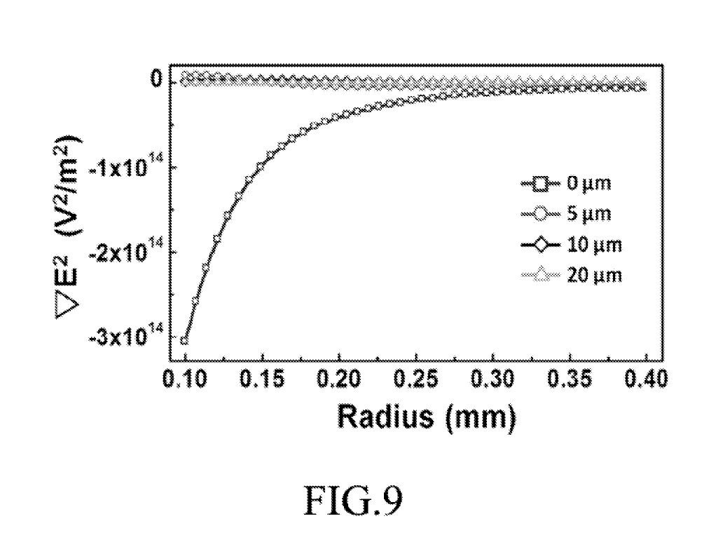

FIG. 7 illustrates another simulation model of a set of two electrode bars 3, which are applied with an alternating current signal with a voltage Vᵢ (Vᵢ=V₀ cos(ωt+φᵢ)), in which, the phase terms φᵢ are 0° and 90° in sequence. In FIG. 7, E_{θ} represents the electric field distribution in the angular direction, and E_{f} represents the electric field distribution in the radial direction. The results of this simulation are shown in FIG. 8, which shows the relation between the electric field distributions in the angular direction and the radial direction, and FIG. 9, which shows the relation between the gradient of an angular electric field strength and the radius at different levitation heights with respect to a surface of the electrode bars 3 from 0 to 20 μm (the levitation heights are 0, 5, 10 and 20 μm, respectively). As shown in FIG. 9, the gradient of the angular electric field strength for zero levitation height decreases with the reduction of the radius of the electrode array 32 from about zero to −3×10¹⁴ V²/m², while the gradient of the angular electric field strength (about 0 V²/m²) for other levitation heights do not decrease or increase with the change of the radius of the electrode array 32, which demonstrates that the radial DEP force (F_{d}) is induced substantially at the surface of the electrode array 32. Since the particles 10 with a larger diameter (greater than 1μm) are levitated by the upward DEP force (F_{z}) to a height above the surface of the electrode array 32, they are dragged by the shear stress-induced force (Fₛ) toward the array center 31 of the electrode array 32. On the other hand, since the particles 10 with a smaller diameter (equal or less than 1 μm) tend to stay at the surface of the electrode array 32, they are dragged by the radial DEP force (F_{D}) toward the outer end of the electrode array 32.

<Experimental Results>

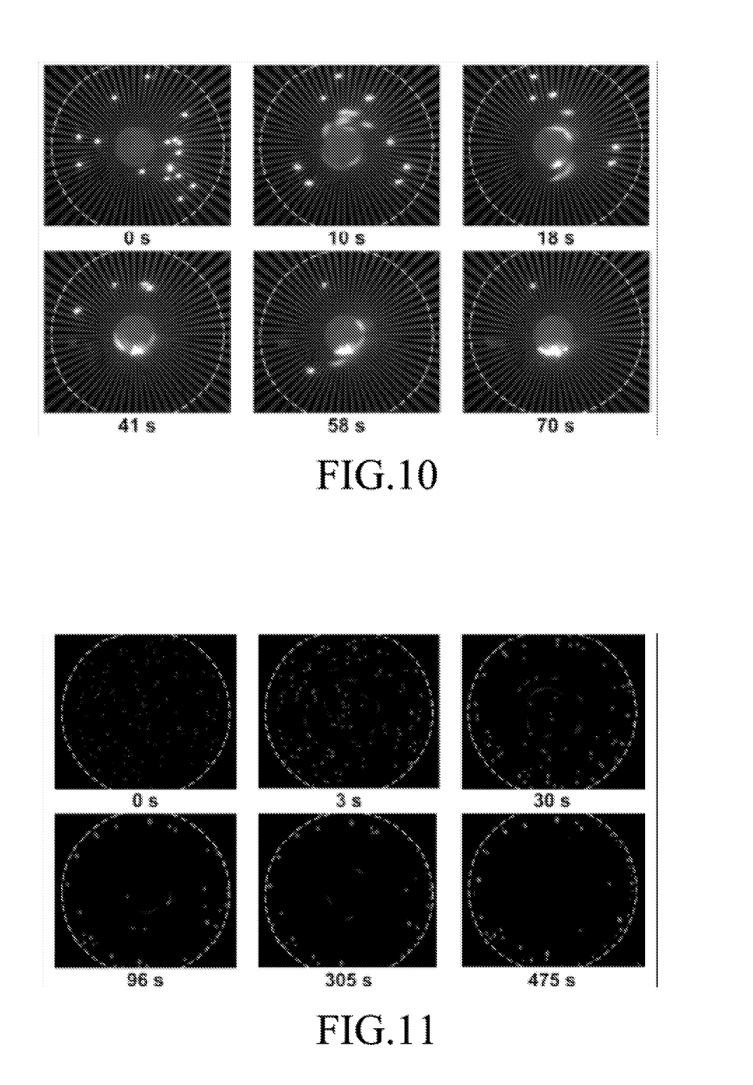

FIG. 10 illustrates the time-sequence behavior of particles having a diameter of about 15 μm in the microfluidic particle separation device of this invention. FIG. 11 illustrates the time-sequence behavior of particles having a diameter of about 1 μm in the microfluidic particle separation device of this invention. The particles shown in FIGS. 10 and 11 are polystyrene beads. When the travelling wave electrical signals are applied to the radially-extending electrode array 32, the particles move in a circular motion because of the circular flow field resulting from the travelling-wave electroosmosis, and the gradient of the circular flow velocity induces the shear stress force in the radial direction, which causes the particles to move toward the array center 31 of the electrode array 32. As shown in FIG. 10, after 70 seconds, almost all of the particles of the larger size (15 μm) are moved to the inner end of the radially-extending electrode array 32. As shown in FIG. 11, after 475 seconds, all of the particles of the small size (1 μm) are moved to the outer end of the radially-extending electrode array 32.

With the inclusion of the radially-extending electrode array 32 in the microfluidic particle separation device of this invention, the aforesaid drawbacks associated with the prior art can be overcome.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A microfluidic particle separation device for separating particles of different sizes in a liquid, said microfluidic particle separation device comprising:
a substrate; and
a plurality of electrode bars formed on said substrate, disposed around an array center, angularly spaced apart from one another, and extending radially with respect to the array center so as to form a radially-extending electrode array that is capable of inducing circular or elliptical shear flow of the liquid through travelling-wave electroosmosis when being applied with a travelling-wave electric potential;
wherein every two adjacent electrode bars cooperatively define therebetween, a gap that has a width which varies with the radius of said radially-extending electrode array so as to induce a radial dielectrophoretic force acting on the particles through radial dielectrophoresis.

2. The microfluidic particle separation device of claim 1, further comprising a liquid container body which is disposed on said substrate and which is formed with a chamber that is adapted to receive the liquid therein and that has a closed end and an open end opposite to said closed end, said open end of said chamber having a periphery that is in contact with said substrate and that surrounds said radially-extending electrode array.

3. The microfluidic particle separation device of claim 1, wherein each of said electrode bars is rectangular in shape.

4. The microfluidic particle separation device of claim 1, wherein each of said electrode bars has a width which increases with the radius of said radially-extending electrode array.

5. The microfluidic particle separation device of claim 4, wherein each of said electrode bars is trapezoid in shape.

6. The microfluidic particle separation device of claim 4, wherein each of said electrode bars is sector in shape.

7. The microfluidic particle separation device of claim 2, wherein said chamber is cylindrical in shape.

8. The microfluidic particle separation device of claim 2, wherein said liquid container body is further formed with an inlet port, an outlet port, an inlet channel interconnecting said inlet port and said chamber, and an outlet channel, interconnecting said outlet port and said chamber.
